(19) United States
(12) Patent Application Publication
(10) Pub. No.: US 2007/0090287 A1
(43) Pub. Date: Apr. 26, 2007

(54) Intelligent SIM acquisition

(76) Inventors: James D. Foote, Sunnyvale, CA (US); Jeffrey T. Kernan, Santa Cruz, CA (US); David W. Peterson, Fremont, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/254,337

(22) Filed: Oct. 20, 2005

(51) Int. Cl. H01J 49/42

(52) U.S. Cl. 250/292; 250/281; 250/282; 250/283

(57) ABSTRACT

A mass spectrometry system includes a quadrupole, a quadrupole control, an ion detector and a controller with an ion detector protection module. The ion detector protection module monitors an output signal of the ion detector and when an accumulation of the output signal derived from receiving ions of a particular mass exceeds a threshold, the protection module causes the controller to prevent the ion detector from receiving more ions of that particular mass. In one implementation, when the threshold is exceeded, the protection module causes the controller to signal the quadrupole control to change the DC voltage so that ions are prevented from passing into the ion detector for the remainder of the SIM period. Accuracy is maintained at high signal levels by integrating long enough to get an accurate measurement. Because the signal level is large, only a short integration time is needed to achieve the measurement accuracy.

### BACKGROUND

Mass spectrometry using a quadrupole ion filter, also referred to as quadrupole mass spectrometry, has been used for many years. A quadrupole mass filter typically uses four parallel rods supplied with a direct current (DC) voltage and a superimposed radio frequency (RF) voltage. At any point in time the (DC) and (RF) are set in such a way as to allow ions of a single mass-to charge ratio (i.e., m/z, often predominately approximated to a single mass ion as is the case when the ions are singly charged, but not to exclude ions having more than one charge) to pass through the quadrupole mass filter. Over time the DC and RF can be varied so as to scan a sequential range of mass ions. Alternatively, the DC and RF can be fixed for a set period of time and allow for monitoring a single mass ion. This analysis of single ions is called single ion monitoring or SIM for short. Typically a specified group of masses are SIMed together in a sequence, which is called a SIM group. The SIM group measurement sequence begins by first setting the DC and RF parameters appropriately for the first ion mass in the sequence. The DC and RF voltages are allowed to stabilize and the selected ions are allowed time to traverse the quadrupole mass filter into the ion detector. The resulting ion current is then integrated for a specified period of time (sometimes referred to as the SIM period) for that ion and recorded. Next the DC and RF are switched to the values necessary to select the next ion mass in the sequence. Again the voltages are allowed to stabilize and selected ions allowed to traverse through the quadrupole mass filter followed by the specified integration period for that ion. This process repeats until all ion masses in the group have been integrated. The measurement sequence itself is then repeated continuously for a specified period of time.

### SUMMARY

In accordance with various aspects, mass spectrometry with ion detector protection is provided. In one aspect, a mass spectrometry system includes a quadrupole mass filter, a quadrupole control, an ion detector and a controller with an ion detector protection module. The module may include any combination of hardware and/or software elements. The ion detector protection module monitors the output signal of the ion detector and when an accumulation of the output signal derived from receiving ions of a particular mass-to-charge ratio exceeds a threshold (accumulation and thresholding may be accomplished through a combination of digital and/or analog control techniques), the protection module causes the controller to prevent the ion detector from receiving more ions. For example, in one implementation, when the threshold is exceeded, the protection module causes the controller to signal the quadrupole control to change the DC voltage so that ions will no longer be directed to the ion detector.

In another aspect, when the threshold for a particular ion is exceeded, the protection module (via the controller and quadrupole control) prevents the ion detector from receiving any more ions for the remaining duration of the SIM period before the next ion in the SIM group is integrated.

In yet another aspect, sampling to a threshold and blanking is not limited to a single accumulation threshold for any given SIM dwell period. It can be further refined into a sampling schedule scheme within a SIM dwell period in which ions can be subject to alternating blanking and detection. In a simple form there could be a SIM accumulation threshold period satisfied at the beginning of a SIM dwell and signal accumulation reactivated after an intermediate blanking period at a final duration period of the SIM dwell. An average signal can be reported for the SIM dwell period in which such average might be more representative of target expectations. In other words, more intelligent sampling and blanking within a SIM Dwell could be further optimized for more desirable SIM target spectra.

In an alternative aspect, when the threshold is exceeded, the protection module sums the remaining SIM period time to an “excess cycle time” parameter or timer, and substantially immediately causes the next ion in the SIM group to be integrated. The controller provides a timestamp for each ion measurement. When all of the ions of the SIM group have been integrated, the protection module (via the controller and quadrupole control) causes (e.g., via the controller and quadrupole control) the quadrupole mass filter to direct ions away from the ion detector for the time duration equal to the “excess cycle time” before initiating the next SIM cycle.

In another alternative aspect, when the threshold is exceeded, the protection module substantially immediately causes the next ion in the SIM group to be integrated. In one implementation, a timestamp is generated each time of a SIM group cycle is started. When all of the ions of the SIM group have been integrated, the next SIM cycle is initiated substantially immediately.

Embodiments may be implemented as a computer process, a computer system (including mobile handheld computing devices) or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

### BRIEF DESCRIPTION OF THE DRAWINGS

Non-limiting and non-exhaustive embodiments are described with reference to the following figures.

FIG. 1 is a block diagram representing an exemplary spectrometry system with ion detector protection module, in accordance with an embodiment.

FIG. 2 is a flow diagram representing operational flow of a mass spectrometer with ion detector protection, in accordance with an embodiment.

FIG. 3 is a flow diagram representing operational flow of a mass spectrometer with ion detector protection, in accordance with another embodiment.

FIG. 4 is a flow diagram representing operational flow of a mass spectrometer with ion detector protection, in accordance with yet another embodiment.

### DETAILED DESCRIPTION

Various embodiments will be described in detail with reference to the accompanying drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many embodiments. Alternative embodiments may be implemented in many different forms other than the exemplary embodiments described herein, and thus the claims attached hereto should not be construed as limited to the embodiments set forth herein. Rather, the disclosed embodiments are provided so that this disclosure will be thorough and complete.

Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

The logical operations of the various embodiments are implemented (1) as a sequence of computer implemented steps running on a computing system and/or (2) as interconnected machine modules within the computing system. The implementation is a matter of choice dependent on the performance requirements of the computing system implementing the embodiment. Accordingly, the logical operations making up the embodiments described herein are referred to alternatively as operations, steps or modules.

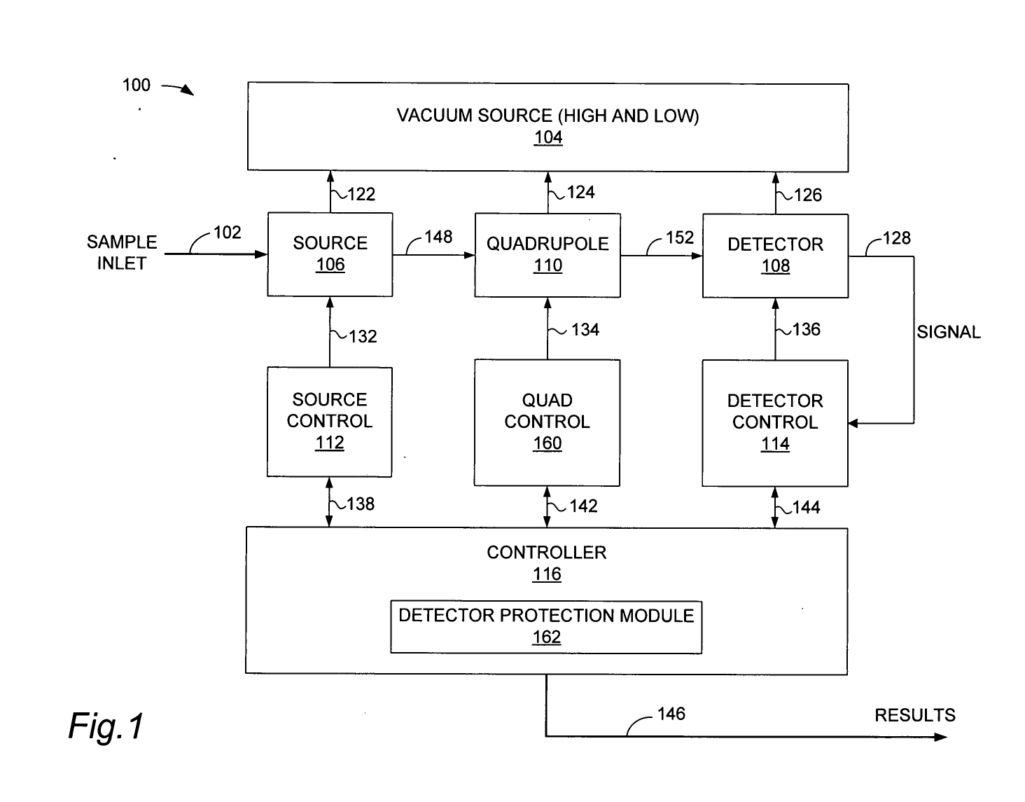

FIG. 1 is a block diagram illustrating a quadrupole mass spectrometer 100, according to one exemplary embodiment. A sample of material to be analyzed is transported via a sample inlet 102 to the source 106. In one embodiment, the sample inlet is a membrane or restricted device used in sampling air and simple gases. In another embodiment, the sample inlet is a more sophisticated device such as, for example, a gas chromatography, liquid chromatography, or solid phase sampler. The source 106 generates ions from the material in the sample inlet 102. The source 106, in various embodiments, is one or more of: an electron ionization source, a chemical ionization source, an electrospray pressure source, an atmospheric pressure source, or any other suitable source that converts the sample in the sample inlet 102 into single or multiple charged ions. The source 106 transports the ions to the quadrupole mass filter 110 via connection 148.

The quadrupole mass filter 110 in this embodiment allows ions of the selected mass-to-charge ratio (m/z) to pass to the output port of the mass filter. When used as an ion filter, and when appropriate RF and DC voltages 134 are applied, the quadrupole mass filter 110 selects ions of a particular m/z from a plurality of ions generated by the source 106. The selected ions then pass via connection 152 to the detector 108. The quadrupole mass filter 110 is used to scan a m/z range to locate particular ions within that m/z range, or is used to select ions of a single m/z in what is referred to as single ion monitoring, or “SIMing” for particular ions. The quadrupole mass filter 110 includes a single quadrupole mass filter in one embodiment. In another embodiment, the quadrupole mass filter 110 includes multiple quadrupole mass filters having collision cells such as used in triple quadrupole mass filter and quadrupole time of flight (abbreviated as q-TOF) instruments. Alternative embodiments include any mass selective detector where similar ion detector protection is provided.

In some embodiments, the mass spectrometer 100 includes a lens unit (not shown) between the source 106 and the quadrupole mass filter 110. The lens unit focuses the ion current onto the quadrupole mass filter 110. In one embodiment, the lens unit is “focused” using a control voltages controlled by the controller 116.

The detector 108 collects ions from the quadrupole mass filter 110 and converts them to electrons (or another appropriate electronic signal) to measure signal intensity of the ions. In various embodiments, the detector 108 includes one or more of continuous conversion dynodes, discrete conversion dynodes, or photomultiplier transducers. The output signal from the detector 108 is provided connection 128 to the detector control electronics 114.

The vacuum source 104, which provides both high and low vacuum, evacuates the source 106 via connection 122, the quadrupole mass filter 110 via connection 124 and the detector 108 via connection 126 to produce the appropriate vacuum required for the specific elements. The vacuum pumps (not shown) in the vacuum source 104 in one embodiment includes rotary vane or dry pumps for low vacuum and turbo molecular or diffusion pumps to provide high vacuum.

The source control 112 in this embodiment includes high and low voltage electronic elements to control the source 106. The control includes both DC static voltages and RF voltages for ion guides and ramped DC voltages as a function of mass. The source control 112 also includes heater control, flow control and filament control in some embodiments.

The quadrupole control 160 in this embodiment (a portion of which will be described in greater detail below) includes high and low voltage electronic RF and DC voltage generators that provide the required voltages to the quadrupole mass filter 110. In some embodiments, the quadrupole control 160 also includes pre and post ion guides to support transmission into or out of the quadrupole mass filter 110.

The detector control 114, in this embodiment, generates the required voltages for the detector 108. In one embodiment, the detector control 114 includes electronic amplifiers to convert or boost the ion signal in order to measure signal intensity of the signal out of the detector 108. In some embodiments the amplifiers are analog elements with various dynamic ranges, while in other embodiments the amplifiers are pulse counters that “count” the ions.

The controller 116, in this embodiment, controls all the elements within the quadrupole mass spectrometer 100. In some embodiments, the controller 116 is a simple control circuit. In other embodiments, the controller 116 is a fully embedded computer processor having an onboard operating system.

The output of the detector 108 on connection 128 is a measurement of the ion intensity and is used by the embedded controller 116 to correlate the sample of interest to the final measurement. The output of the embedded controller 116 on connection 146 comprises data that is used directly or indirectly by elements located downstream of the quadrupole mass spectrometer 100 to interpret and correlate the sample from the sample inlet to the final measurement. Typically, the results are mass spectra or some form of mass information related to the sample ions.

In SIM operation, long ion dwell times are often used to detect very small signal levels. As the customer establishes the analytical calibration curve, they must inject standards (and samples) throughout the calibration range. Often times these concentrations are much larger (up to 100,000 times stronger) than the very small signal levels that need to be accurately detected. The resultant high signal output of the large signal concentrations can be very stressful to the ion detector. The high output current levels can cause the ion detector to lose sensitivity. Thus: the higher the concentration, the larger the current and the greater the loss in sensitivity. The loss in sensitivity can have two bad effects. First, the lifetime of the ion detector can be reduced and secondly, the calibration can have less certainty. Associated with signal degradation is degradation of the ion detector performance when subjected to high ion current.

In accordance with this embodiment, controller 116 includes a detector protection module 162. The detector protection module 162 can be used to address degradation of the ion detector performance that may occur when subjected to high current. Embodiments of detector protection module 162 are described below that allow full sensitivity and also allow the user to minimize the degradation of the ion detector at high signal concentrations while maintaining accuracy.

One embodiment includes an algorithm that electrically minimizes the current into the detector 108 at high signal levels but allows the full signal into the detector 108 during low signal levels. Accuracy is maintained at high signal levels by integrating long enough to get an accurate measurement. Because the signal level is large, only a short integration time (i.e., a fraction of the SIM time for the ion) is needed to achieve the measurement accuracy. During the remaining SIM time, the ion current (to the detector 108) can be removed or otherwise prevented from reaching the detector 108. Thus the detector 108 only sees a small fraction of total high signal current. At low signal levels, detection protection module 162 allows the ion current to reach the detector 108 for the entire SIM time.

The removal (also referred to herein as “blanking”) of ion current into the detector 108 can be sequenced a number of different ways. In one embodiment, the detector protection module 162 causes the controller 116 (via the quadrupole control 160) to prevent ions from passing into the detector 108 for the duration of the SIM time prior to cycling to the next SIM ion. This approach is referred to herein as “immediate blanking”.

In an alternative embodiment, immediate blanking is not limited to a single accumulation threshold for any given SIM dwell period. It can be further refined into a sampling schedule scheme within a SIM dwell period in which ions can be subject to alternating blanking and detection. In a simple form there could be a SIM accumulation threshold period satisfied at the beginning of a SIM dwell and signal accumulation reactivated after an intermediate blanking period at a final duration period of the SIM dwell. An average signal can be reported for the SIM dwell period in which such average might be more representative of target expectations. In other words, more intelligent sampling and blanking within a SIM Dwell could be further optimized for more desirable SIM target spectra.

Rather than immediate blanking, in an alternative embodiment, the detector protection module 162 causes the controller 116 (via the quadrupole control 160) to simply increment to the next ion of interest in the SIM group. After integrating all ions in the SIM group (some, none or all of which may have been integrated for a short period), the detector protection module 162 then blanks all ions for the remaining duration of the SIM group cycle time. This approach is referred to herein as “end cycle blanking.” The end blanking approach has virtually the same effect as immediate blanking. There is a slight potential sampling skew that may occur as the ion concentration increases, but the overall sample rate will remain fixed. Since timing is no longer deterministic, the reading is timestamped in some embodiments. Detector protection is maintained.

In yet another embodiment, the detector protection module 162 causes the controller 116 (via the quadrupole control 160) to begin the next integration cycle substantially immediately. This approach is referred to herein as “continuous cycling”. In the continuous cycling approach, the system-sampling rate will vary with signal level. To associate the result to the when the ion current was sampled, the readings are timestamped in some embodiments.

In various embodiments, detector protection module 162 achieves blanking by one or more of: changing lens voltages and changing quadrupole voltages (e.g., to shift the quadrupole mass location of the quadrupole mass filter 110 to a known unpopulated mass location). In one embodiment, detector the protection module 162 causes the quadrupole control 160 (via the controller 116) to modulate the DC voltages on the quadrupole mass filter 110 in such as way as to effectively prevent any ions from passing into the detector 108. The quadrupole DC control voltage responds rapidly and precisely, requiring no additional circuitry or hardware. However in other embodiments other suitable blanking methods are supported by the detector protection module 162 to implement blanking.

Although a quadrupole mass filter is used in the above-described embodiments, alternative embodiments may use mass filters with a different number of poles or electrodes (e.g., hexapole and octapole mass filters). Further, a scan sequence is similar to a SIM sequence except that the step increment in a scan sequence is uniform over a specified mass range where the increment is typically a fractional part of a unit mass. In general, scanning can be modeled as a subset of SIMing. Therefore, the descriptions above are intended to apply to scanning as well as SIMing.

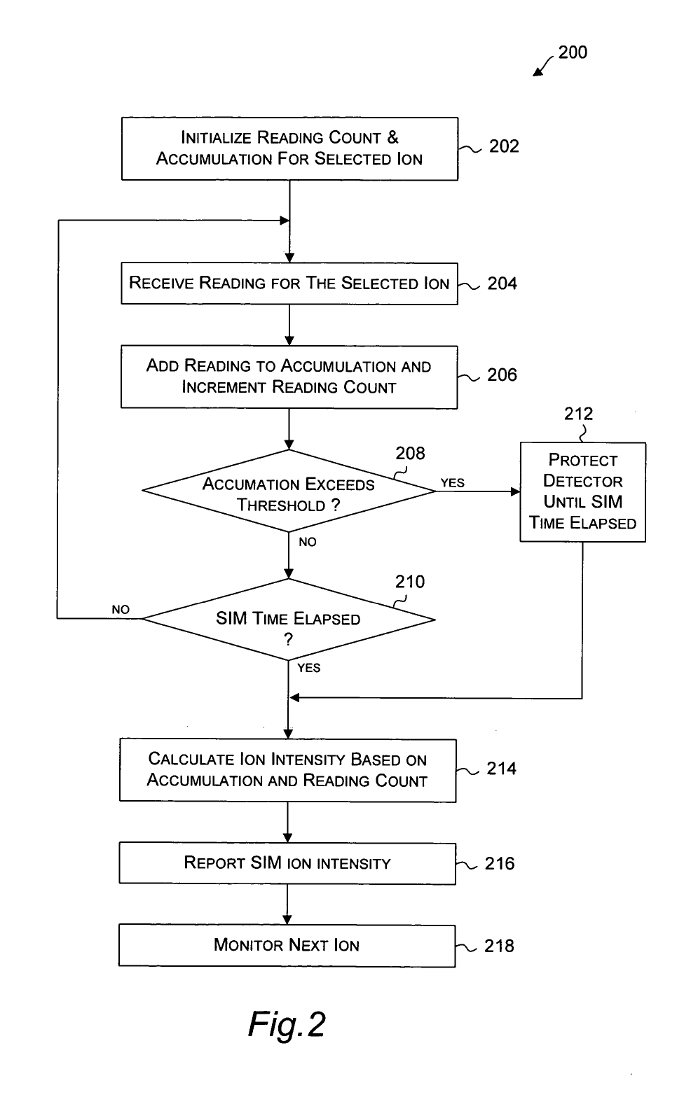

FIG. 2 illustrates an exemplary operational flow 200 of a mass spectrometer with ion detector protection, in accordance with an embodiment. The operational flow 200 may be performed in any suitable computing environment. For example, the operational flow 200 may be executed by a computing environment implemented by controller 116 (FIG. 1).

At an operation 202, a SIM time, a reading count (i.e., the number of readings) and an accumulation (i.e., an accumulation or integration of readings) is initialized for a selected ion of a SIM group. In one embodiment, a controller such as the controller 116 (FIG. 1) is configured to initialize the reading count and the accumulation by setting the values for these parameters to zero.

At an operation 204, a reading from an ion detector such is received. In one embodiment, the reading is taken as in a conventional mass spectrometer. For example, in one implementation, the reading is a sample of an output signal generated from an ion detector such as the detector 108 (FIG. 1) taken by the controller 116.

At an operation 206, the reading from operation 204 is added to the accumulation that was initialized at operation 202. In one embodiment, the reading is added to the accumulation as in a conventional mass spectrometer. In addition, the reading count is incremented. In one embodiment, the controller 116 has been configured with a “measurement” program that adds the reading to the accumulation and increments the reading count.

At an operation 208, it is determined whether the accumulation exceeds a threshold. In one embodiment, the threshold is set to a value that limits or reduces degradation of the ion detector while still allowing accurate measurement of the ion intensity. For example, the threshold may be determined empirically for the model of the ion detector used in the mass spectrometer. In one embodiment, the controller is configured to determine whether the accumulation exceeds the threshold. For example, in one implementation the measurement program (mentioned at operation 206) executed by the controller has a protection module or component such as detector protection module 162 (FIG. 1) that determines whether the accumulation exceeds the threshold. If it is determined that the accumulation does not exceed the threshold, the operational flow 200 proceeds to an operation 210.

At operation 210, it is determined whether the SIM time has elapsed. In one embodiment, the controller is configured to determine whether the SIM time has elapsed as in a conventional mass spectrometer. If it is determined that the SIM time has not elapsed, the operational flow 200 returns to operation 204 to receive another reading from the ion detector.

Returning to operation 208, if it is determined that the accumulation exceeds the threshold, the operational flow 200 proceeds to an operation 212.

At operation 212, the ion detector is protected (i.e., prevented from receiving more of the selected ions) until the SIM time has elapsed. In one embodiment, the aforementioned protection module causes the controller to blank the ion current to the ion detector. In one example implementation, the controller provides one or more control signals to a quadrupole control (e.g., quadrupole control 160 of FIG. 1) to generate a DC control signal that effectively prevents any more of the selected ions to be directed to the ion detector.

Returning to operation 210, if it is determined that the SIM time has elapsed, the operational flow 200 proceeds to an operation 214. In addition, the operational flow may also proceed to operation 214 after performing operation 212.

At operation 214, the ion intensity is calculated based on the resultant accumulation and reading count. In one embodiment, the controller calculates the ion intensity by dividing the accumulation by the reading count.

At an operation 216, the ion intensity from operation 214 is reported. In one embodiment, the controller stores the ion intensity in memory for use by other by elements located downstream of the mass spectrometer to interpret and correlate the sample from the sample inlet to the final measurement. Typically, the results are mass spectra or some form of mass information related to the sample ions.

The operational flow 200 can then return to operation 202 for a next ion in the SIM group.

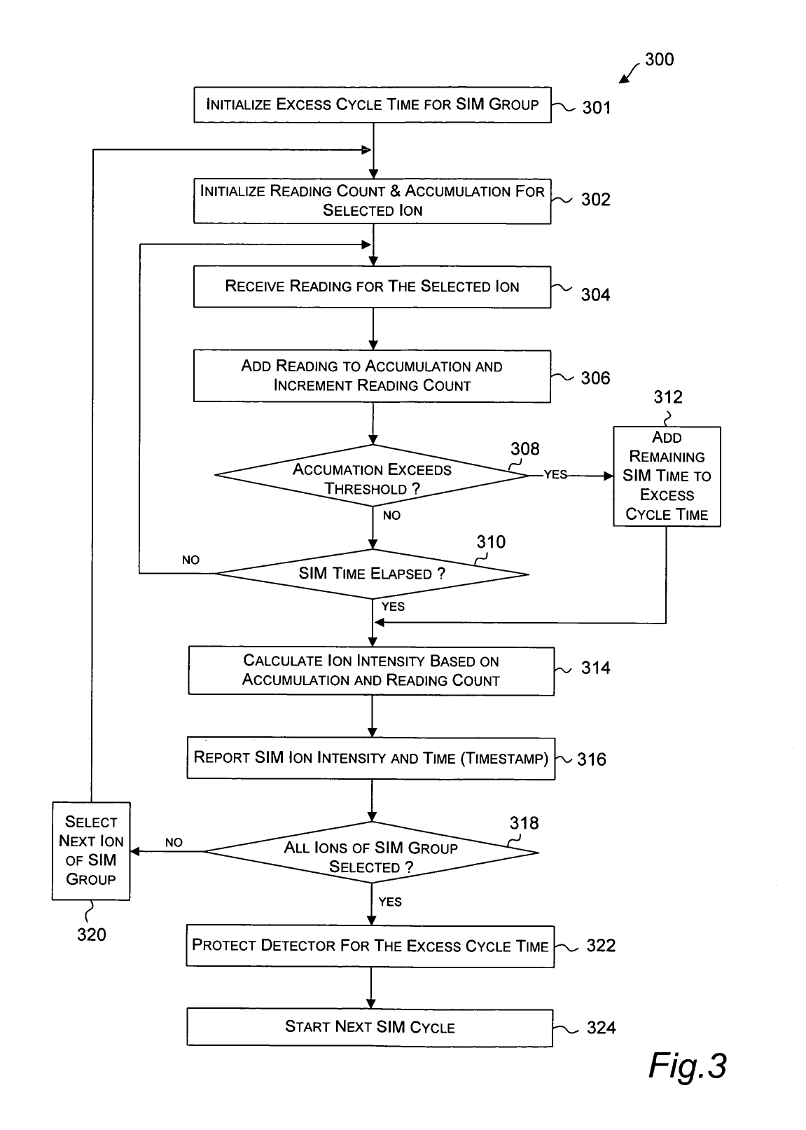

FIG. 3 illustrate an operational flow 300 of a mass spectrometer with ion detector protection, in accordance with another embodiment. The operational flow 300 may be performed in any suitable computing environment. For example, the operational flow 300 may be executed by a computing environment implemented by controller 116 (FIG. 1).

At an operation 301, an excess cycle time for a SIM group is initialized. In one embodiment, a controller such as the controller 116 (FIG. 1) is configured to initialize the group end cycle time to a value of zero.

At operation 302, a reading count (i.e., the number of readings) and an accumulation (i.e., an accumulation or integration of readings) is initialized for a selected ion of the SIM group. In one embodiment, the aforementioned controller is configured to initialize the SIM time, reading count and the accumulation by setting the values for these parameters to zero.

At an operation 304, a reading from an ion detector such is received. In one embodiment, the reading is taken as in a conventional mass spectrometer. For example, in one implementation, the reading is a sample of an output signal generated from an ion detector such as the detector 108 (FIG. 1) taken by the controller 116.

At an operation 306, the reading from operation 304 is added to the accumulation that was initialized at operation 302. In one embodiment, the reading is added to the accumulation as in a conventional mass spectrometer. In addition, the reading count is incremented. In one embodiment, the controller 116 has been configured with a “measurement” program that adds the reading to the accumulation and increments the reading count.

At an operation 308, it is determined whether the accumulation exceeds a threshold. In one embodiment, the threshold is set to a value that limits or reduces degradation of the ion detector while still allowing accurate measurement of the ion intensity. For example, the threshold may be determined empirically for the model of the ion detector used in the mass spectrometer. In one embodiment, the controller is configured to determine whether the accumulation exceeds the threshold. For example, in one implementation the measurement program (mentioned at operation 306) executed by the controller has a protection module or component such as detector protection module 162 (FIG. 1) that determines whether the accumulation exceeds the threshold. If it is determined that the accumulation does not exceed the threshold, the operational flow 300 proceeds to an operation 310.

At operation 310, it is determined whether the SIM time has elapsed. In one embodiment, the controller is configured to determine whether the SIM time has elapsed as in a conventional mass spectrometer. If it is determined that the SIM time has not elapsed, the operational flow 300 returns to operation 304 to receive another reading from the ion detector.

Returning to operation 308, if it is determined that the accumulation exceeds the threshold, the operational flow 300 proceeds to an operation 312.

At operation 312, the remaining SIM time is summed into the excess cycle time that was initialized at operation 301.

Returning to operation 310, if it is determined that the SIM time has elapsed, the operational flow 300 proceeds to an operation 314. In addition, the operational flow may also proceed to operation 314 after performing operation 312.

At operation 314, the ion intensity is calculated based on the resultant accumulation and reading count. In one embodiment, the controller calculates the ion intensity by dividing the accumulation by the reading count.

At an operation 316, the ion intensity from operation 314 is reported. In one embodiment, the controller stores the ion intensity in memory for use by other by elements located downstream of the mass spectrometer to interpret and correlate the sample from the sample inlet to the final measurement. Typically, the results are mass spectra or some form of mass information related to the sample ions. A timestamp is also generated and stored to record the time at which the ion intensity was recorded.

At an operation 318, it is determined whether all of the ions of the SIM group have been selected in this cycle. In one embodiment, the controller is configured to determine whether all of the ions of the SIM group have been selected in this cycle. If it is determined that there is still one or more ions to be selected, the operational flow 300 proceeds to an operation 320.

At operation 320, the next ion of the SIM group is selected. In one embodiment, the controller is configured to select the next ion of the SIM group as in a conventional mass spectrometer. For example, the controller can cause the quadrupole control to provide appropriate DC and RF voltages to the quadrupole to select the next ion in the SIM group. The operational flow 300 then returns to operation 302 described above.

Returning to operation 318, if it is determined that all of the ions of the SIM group have been selected, the operational flow proceeds to an operation 322.

At operation 322, the ion detector is protected (i.e., prevented from receiving more of the selected ions) for a duration equal to the excess cycle time. In one embodiment, the aforementioned protection module causes the controller to blank the ion current to the ion detector for a duration equal to the excess cycle time. In one example implementation, the controller provides one or more control signals to a quadrupole control (e.g., quadrupole control 160 of FIG. 1) to generate a DC control signal that shifts the quadrupole mass to a known unpopulated mass location, which effectively prevents any more of the selected ions to be directed to the ion detector.

The operational flow 300 can then return to operation 301 for a next SIM cycle.

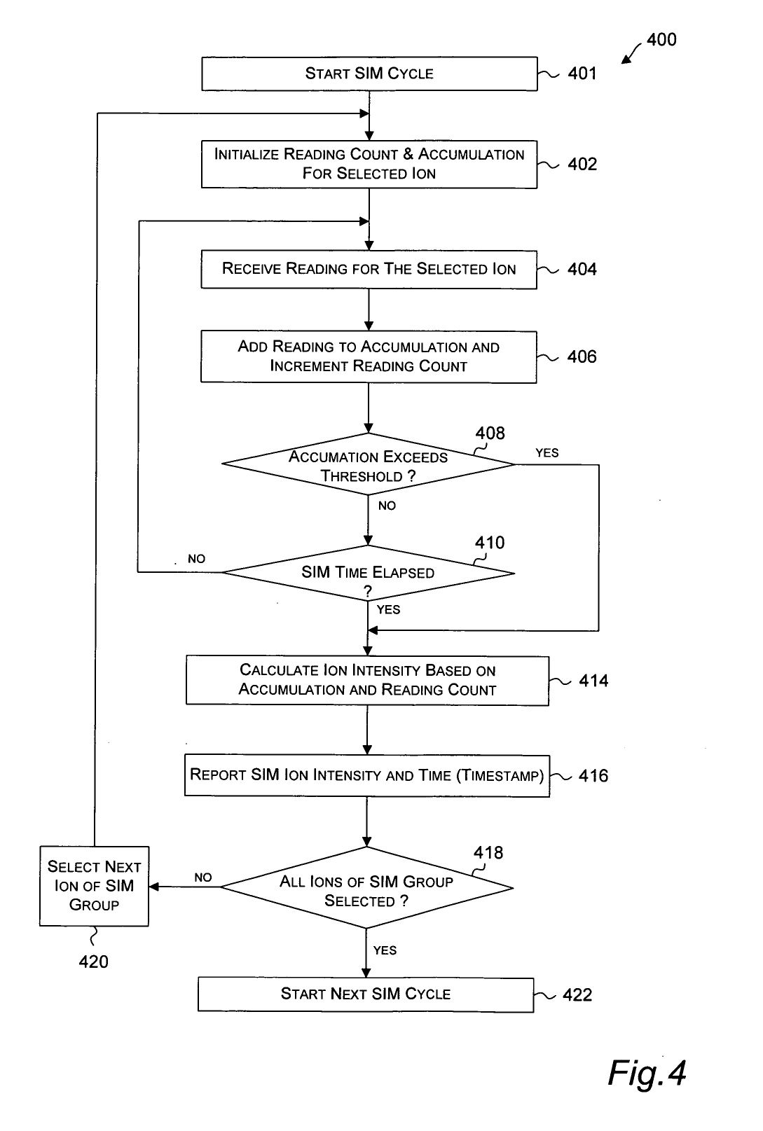

FIG. 4 illustrate an operational flow 400 of a mass spectrometer with ion detector protection, in accordance with yet another embodiment. The operational flow 400 may be performed in any suitable computing environment. For example, the operational flow 400 may be executed by a computing environment implemented by controller 116 (FIG. 1).

At an operation 401, a SIM cycle is initiated.

At an operation 402, a SIM time, a reading count (i.e., the number of readings) and an accumulation (i.e., an accumulation or integration of readings) is initialized for a selected ion of the SIM group. In one embodiment, the aforementioned controller is configured to initialize the SIM time, reading count and the accumulation by setting the values for these parameters to zero.

At an operation 404, a reading from an ion detector such is received. In one embodiment, the reading is taken as in a conventional mass spectrometer. For example, in one implementation, the reading is a sample of an output signal generated from an ion detector such as the detector 108 (FIG. 1) taken by the controller 116.

At an operation 406, the reading from operation 404 is added to the accumulation that was initialized at operation 402. In one embodiment, the reading is added to the accumulation as in a conventional mass spectrometer. In addition, the reading count is incremented. In one embodiment, the controller 116 has been configured with a “measurement” program that adds the reading to the accumulation and increments the reading count.

At an operation 408, it is determined whether the accumulation exceeds a threshold. In one embodiment, the threshold is set to a value that limits or reduces degradation of the ion detector while still allowing accurate measurement of the ion intensity. For example, the threshold may be determined empirically for the model of the ion detector used in the mass spectrometer. In one embodiment, the controller is configured to determine whether the accumulation exceeds the threshold. For example, in one implementation the measurement program (mentioned at operation 406) executed by the controller has a protection module or component such as detector protection module 162 (FIG. 1) that determines whether the accumulation exceeds the threshold. If it is determined that the accumulation does not exceed the threshold, the operational flow 400 proceeds to an operation 410.

At operation 410, it is determined whether the SIM time has elapsed. In one embodiment, the controller is configured to determine whether the SIM time has elapsed as in a conventional mass spectrometer. If it is determined that the SIM time has not elapsed, the operational flow 400 returns to operation 404 to receive another reading from the ion detector. However, if it is determined that the SIM time has elapsed, the operational flow 400 proceeds to an operation 414. In addition, the operational flow may also proceed to operation 414 from operation 408 if it was determined that the accumulation exceeded the threshold.

At operation 414, the ion intensity is calculated based on the resultant accumulation and reading count. In one embodiment, the controller calculates the ion intensity by dividing the accumulation by the reading count.

At an operation 416, the ion intensity from operation 414 is reported. In one embodiment, the controller stores the ion intensity in memory for use by other by elements located downstream of the mass spectrometer to interpret and correlate the sample from the sample inlet to the final measurement. Typically, the results are mass spectra or some form of mass information related to the sample ions. A timestamp is also generated and stored to record the time at which the ion intensity was recorded.

At an operation 418, it is determined whether all of the ions of the SIM group have been selected in this cycle. In one embodiment, the controller is configured to determine whether all of the ions of the SIM group have been selected in this cycle. If it is determined that there is still one or more ions to be selected, the operational flow 400 proceeds to an operation 420.

At operation 420, the next ion of the SIM group is selected. In one embodiment, the controller is configured to select the next ion of the SIM group as in a conventional mass spectrometer. For example, the controller can cause the quadrupole control to provide appropriate DC and RF voltages to the quadrupole to select the next ion in the SIM group. The operational flow 400 then returns to operation 402 described above.

Returning to operation 418, if it is determined that all of the ions of the SIM group have been selected, the operational flow proceeds to an operation 422.

At operation 422, the next SIM group cycle is started. For example the operational flow 400 can return to operation 401 for the next SIM group cycle.

Reference has been made throughout this specification to “one embodiment,” “an embodiment,” or “an example embodiment” meaning that a particular described feature, structure, or characteristic is included in at least one embodiment. Thus, usage of such phrases may refer to more than just one embodiment. Furthermore, the described features, structures, or characteristics may be combined in any suitable manner in one or more embodiments.

One skilled in the relevant art may recognize, however, that embodiments may be practiced without one or more of the specific details, or with other methods, resources, materials, etc. In other instances, well known structures, resources, or operations have not been shown or described in detail merely to avoid obscuring aspects of the embodiments.

The various embodiments described above are provided by way of illustration only and should not be construed to limit the invention. Those skilled in the art will readily recognized various modifications and changes that may be made to the present invention in view of the example embodiments and applications illustrated and described herein, an without departing from the true spirit and scope of the present invention, which is set forth in the following claims.

1. A method of reducing degradation of an ion detector of a mass spectrometer, the method comprising:
receiving a reading from the ion detector in detecting ions of a selected mass and charge;
adding the reading to an accumulation;
incrementing a reading count;
determine an intensity value based on the accumulation and the reading count at the end of a preselected time; and
selectively protecting the ion detector in response to a determination that the accumulation exceeded a threshold.

2. The method of claim 1 wherein protecting the ion detector comprises controlling a DC voltage provided to a mass filter of the mass spectrometer so as to prevent ions from being detected by the ion detector.

3. The method of claim 2 wherein protecting the ion detector further comprises changing a RF voltage provided to the mass filter.

4. The method of claim 1 wherein protecting the ion detector comprises controlling a lens unit of the mass spectrometer to direct ions of the selected mass and charge from being detected by the ion detector

5. The method of claim 1 wherein controlling the lens unit comprises causing the lens unit to cause an ion stream from being directed to the mass filter.

6. The method of claim 1 wherein protecting the ion detector comprises protecting the ion detector until a single ion monitoring (SIM) time has elapsed.

7. The method of claim 1 wherein protecting the ion detector comprises adding a remaining time to an excess cycle time and selecting a next ion of a single ion monitoring (SIM) group to be detected.

8. The method of claim 7 wherein protecting the ion detector further comprises preventing ions of the SIM group from being directed to the ion detector until the excess cycle time has elapsed.

9. The method of claim 1 wherein protecting the ion detector comprises causing the next ion of a single ion group to be directed to the ion detector.

10. The method of claim 9 further comprising initiating a next SIM cycle at a conclusion of a current SIM cycle.

11. The method of claim 9 further comprising providing a timestamp corresponding to a time period during which the reading was received.

12. A system for use in a mass spectrometer, the system comprising:
an ion detector;
a mass filter to selectively direct ions of a selected mass and charge to the ion detector; and
a controller to selectively accumulate readings from the ion detector in detecting ions of the selected mass and charge and to selectively protect the ion detector in response to a determination that the accumulation exceeded a threshold.

13. The system of claim 12 wherein the controller is to selectively protect the ion detector by controlling the mass filter to direct ions of the selected mass and charge from being detected by the ion detector.

14. The system of claim 13 wherein controlling the mass filter comprises changing a DC voltage provided to the mass filter.

15. The system of claim 12 further comprising a lens unit operatively coupled to the mass filter, wherein protecting the ion detector comprises controlling the lens unit to direct ions of the selected mass and charge from being detected by the ion detector

16. The system of claim 12 wherein controlling the lens unit comprises controlling the lens unit to cause an ion stream from being directed to the mass filter.

17. The system of claim 12 wherein protecting the ion detector comprises protecting the ion detector until a single ion monitoring (SIM) time has elapsed.

18. The system of claim 12 wherein protecting the ion detector comprises adding a remaining time to an excess cycle time and selecting a next ion of a single ion monitoring (SIM) group to be detected.

19. The system of claim 18 wherein protecting the ion detector further comprises preventing ions of the SIM group from being directed to the ion detector until the excess cycle time has elapsed.

20. The system of claim 12 wherein protecting the ion detector comprises causing a different ion to be directed to the ion detector.

21. The system of claim 20 wherein the controller is further to provide a timestamp corresponding to a time period during which the readings are accumulated.

22. The system of claim 12 wherein the mass filter comprises a quadrupole mass filter.

23. An apparatus for use in a mass spectrometer, the apparatus comprising:
an ion detector;
a mass filter operatively coupled to the ion detector;
means for receiving a reading from the ion detector in detecting ions of a selected mass and charge;
means for adding the reading to an accumulation;
means for incrementing a reading count;
means for determining an intensity value based on the accumulation and the reading count; and
means for selectively protecting the ion detector in response to a determination that the accumulation exceeded a threshold.

24. The apparatus of claim 23 wherein the mass filter is selected from a group comprising a quadrupole mass filter, a hexapole mass filter or an octapole mass filter.
